(19) United States
(12) Patent Application Publication
(10) Pub. No.: US 2007/0075018 A1
(43) Pub. Date: Apr. 5, 2007

(54) Method and product for the residential and commercial aquatic environment

(76) Inventors: Michael Richter, Oceanside, NY (US); Douglas A. Dent, New Hope, PA (US); Mark Krupka, Tabernacle, NJ (US)

Correspondence Address: Ecological Laboratories, Inc., 215 Main Street, Freeport, NY, 11520, US

(21) Appl. No.: 11/238,793

(22) Filed: Sep. 30, 2005

(51) Int. Cl. C02F 3/04; C02F 3/34

(52) U.S. Cl. 210/615; 210/616; 210/617

(57) ABSTRACT

A product and a method for treating a body of water having organic and ammonia impurities therein. The product consists of a filter media having been pre-colonized with microorganisms capable of organic oxidation (organic removal) and a media having been pre-colonized with nitrifying bacteria, the product is contained in a bag. The thus pre-colonized media in a bag is placed in a body of water having a water flow therein.

### FIELD OF THE INVENTION

The invention is directed to direct fermentation bio-technologies for developing, formulating microbial technologies and products designed for the residential and commercial environment, such as the pond and aquarium segments and targets enhancement in microbial performance specific to necessary microbial functions in aquatic environments as follows:
1) enhanced herotroph biological oxidation of organic matter (breakdown and removal;
2) enhanced biological oxidation and removal of ammonia via nitrifying microorganism in the microbial process of nitrification.

### BACKGROUND OF THE INVENTION

The inventive discoveries are designed specifically to speed and enhance overall biological reactions in two distinct microbial oxidation categories that are essential and necessary in aquatic environments. The categories are the oxidation and removal of organic waste matter via herotroph microorganisms and the biological oxidation and removal of ammonia via a nitrifying microorganism in a process called nitrification.

These two categories utilize different species of microorganisms; however, their enhancement technology shares the same improved technology by providing additional surface area and pre-colonization to promote a more rapid biological process for both microbial functions and reactions.

1) Organic Oxidation

The inventive discovery is designed to speed the biological removal of waste material from the aquatic environment via herotroph microorganisms and to promote a cleaner aquatic environment to support a healthy marine life. The inventive concepts are directed to a novel blending of surface media in combination with herotroph microorganisms.

On the market there are biologically based products and supporting technologies that are designed to assist and speed the necessary biological oxidation process responsible for the removal of waste organic matter from pond and aquatic water. Biological oxidation of waste organic matter is accomplished by microorganisms and by selecting microbes and technologies to enhance water quality by increasing the rate of biological oxidation of waste organic matter to assure an environment that will support aquatic life forms.

Water pollution comes from a variety of marine species confined in a specific volume of water (closed system); as well as, the continued growth of the fish, the addition of their offsprings (all aquatic species), their waste, excessive feeding of the fish, and air born pollutants.

These factors contribute to a rapid increase in water pollution as the organic-loading to the confined body of water is greater than the natural biological oxidation of waste organic matter by the indigenous microorganism. These factors lead to reduced water quality and the potential loss of aquatic life from pollution. Water quality is effected by the increased organic loading associated with closed aquatic features that contain large numbers of marine life, fish for example, as these factors contribute to water pollution via the high levels of organic waste and breakdown to ammonia.

The inventive concept for organic removal enhancement provides for a pre-inoculation of types of water purification filter media. The microbial inoculated media is fully activated with a consortium of attached herotroph microorganisms that are capable of rapid response to organic waste matter following an addition to any aquatic environment, such as ponds or aquariums. Once the filter media is exposed to water containing organic matter, the herotroph microorganisms will germinate, grow and form new microbial colonies via cell division. The existing cultures, and pre colonized herotroph microbes will form additional microbial attachments. The combined microorganisms will absorb and break down organic matter while improving the performance of their media specific to a bio-film formation and overall removal of waste matter. The pre-inoculated media, such as filter pads and other related materials will increase the microbial functions specific to achieving rapid biological oxidation of organic matter within bio-filters and other related biological water clarification systems and equipment. The combination of select media and attached microbes provides for s significant improvement in the rate (speed and time) of waste organic removal, i.e. biological oxidation of organic matter via enhanced surface area and microbes.

2) Nitrification

The inventive discovery is designed to speed the biological oxidation of ammonia by enhanced nitrification in the aquatic environment and to promote a less toxic environment (ammonia removal) as necessary to support a healthy marine life. The inventive concept is directed to a novel blending of surface media in combination with pre-colonization of select nitrifying microorganisms.

This process requires nitrifying microorganisms capable of oxidizing ammonia to nitrite and then biologically converting the nitrite to nitrate gas. This requires select strains of microorganisms i.e. Nitrosomonas, Nitrospira, and Nitrobactor, and specific environmental growth conditions. This invention combines select microorganisms and novel growth factors to speed the biological removal of ammonia from the aquatic environment and to eliminate the toxic effects of ammonia to promote and maintain a healthy marine life.

The inventive concepts are directed to a novel blending of surface media and nitrifying microorganisms.

On the present market there are biologically based nitrifying products and supporting technologies that are designed to assist and speed the necessary biological oxidation process responsible for the removal of ammonia from pond and aquarium water. Biological oxidation of the ammonia is accomplished by nitrifying microorganisms and by augmenting with selecting nitrifying microbes to speed and enhance water nitrification. Nitrification is responsible for reducing the toxic effects of ammonia by increasing the rate of biological oxidation of ammonia to nitrite followed by the conversion of the nitrite to nitrate gas to assure a toxic free environment that will support aquatic life forms.

### BRIEF DESCRIPTION OF THE INVENTION

The inventive concept provides for a pre-inoculation of nitrifying microorganism to all types of water purification filter media. The microbial inoculated filter media is fully activated with a consortium of attached nitrifying microorganisms that capable of a rapid response to ammonia following an addition to any aquatic environment, such as ponds or aquariums. Once the filter media is exposed to water containing organic matter, the microorganisms will germinate, grow and form new microbial substances that will aid in the oxidation and elimination of toxic ammonia.

The system's existing cultures, and the new nitrifying microbes will form additional microbial attachments, the combined microorganisms will absorb and break down ammonia and improve the performance of the media specific to a greater rate of nitrification via an increased and more effective nitrifying bio-film formation and an overall increase in the rate of ammonia removal. The pre-inoculated nitrifying media, such as filter pads and other related materials, will increase the microbial functions specific to achieving rapid biological oxidation of ammonia within bio-filters and other related biological water clarification systems and equipment.

### DETAILED DESCRIPTION OF THE INVENTION

As mentioned above, the inventive concept is based on pre-inoculating or pre-colonizing certain types of biological filter media with selected strains of nitrifying bacteria. The benefits of such pre-colonizing are in that there is no wait for nitrification to occur and it improves organic filtration efficiency. Examples of such pre-colonizing filter media follow below:

### Plastic Filter Media

Biological Pin Balls

The use of biological pin balls provides the highest surface area exposure for superior biological filtration. They are excellent for oxygen and gas exchange. When they are used in a loose state, they fit most skimmers or filters. Another advantage is that the pin balls may be snapped together at their ends to form bio-cords. Bio-pin balls are also ideal for nitrifying bacteria to colonize and to thrive. Bio-pin balls can be placed into “master” media bags and set directly into the pond. This will be explained below.

Biological Ceramic Rings:

These rings offer optimum surface area which can support large bacterial colonies. They do not break down like other filter media.

Biological Mini Pads:

The use of these Mini Pads provides the highest area for nitrification and additionally allows for high water flow without any clogging. They fit in most skimmers and filters while easily trapping suspended dirt and debris

Zeolite:

Zeolite is any group of hydrated silicates of aluminum with alkali metals. In a chip form they have the advantage of removing ammonia while protecting against ammonia spikes. Zeolite removes dissolved organics and improves fish mortality rates and reduces fish stress while improving the water quality. The Zeolite chips may be recharged by cleaning at certain intervals. After cleaning, they should be re-colonized with nitrifying bacteria for immediate nitrification.

### Carbon Pellets

Activated Carbon:

The benefit of using carbon pellets is that the pellets remove medications, remove odors and dyes. They also remove organic pollutants and absorb liquefied impurities. The activated carbon pellets should be used at the highest grade available. The activated carbon pellets last twice as long as most carbons and treat as much waste when compared to most other carbons.

Carbon Pellets and Zeolite Chips Combined:

The benefit of both carbon pellets and Zeolite chips have been discussed above. However, to use both of them in a combination results in a double filtration while taking advantage of the benefits of both in a pre-colonized filter media.

### Pre-Colonization by Bacteria

Bacteria is a substance of numerous nitrifying microscopic substances in combination with spherical rod-shaped or spiral organisms, various species of which are concerned in fermentation and putrefaction. The putrefaction of water bodies and removal of toxic ammonia is the inventive concept of this specification.

### Nitrifying Bacteria

1. Nitrosomanos
2. Nitrobacter
3. Nitrospira

The above recited nitrifying bacteria are pre-inoculated into the various filter media described above. The benefits of pre-inoculation or pre-colonization with the nitrifying bacteria recited above, is that it significantly improves the speed of achieving nitrification by enhancing the nitrification process. Under optimum conditions the development time for nitrifying bacteria is from 8 to 16 hours for cell division to occur. With pre-colonization of nitrifying microbes, the media can rapidly establish to nitrification process and speeds ammonia removal by nitrification. There is no reason to wait for long periods for nitrification to occur. Nitrifyers and nitrification eliminate the toxic effects of ammonia. Nitrosomanos converts ammonia to nitrite, while Nitrobacter, and Nitrospira convert nitrite to nitrate.

### Method of Use of Pre-Colonized Filter Media

The pre-colonized filter media is pre-packed in Nylon media bags. These pre-packed bags can be placed into a “master” media bag and set directly into a pond, preferably, where there is a flow of circulation of water that will enhance the distribution of nitrified bacteria. The prepackaged bags easily fit into most biological filters, pressurized filters, filter falls, skimmers and skimmer baskets. The media is sealed in the Nylon bags to help minimize the effects of a mess generated by loose pellets or chips. They are easy to handle and easy to change.

What we claim is:

1. a product for treating a body of water for ammonia impurities contained therein, said product including a pre-colonized filter media contained in a prepackage, said pre-colonized filter media having been pre-colonized with nitrifying microorganisms.

2. The product of claim 1, wherein said pre-colonized filter media is contained in a prepackaged bag.

3. The product of claim 2, wherein said bag is made of Nylon.

4. The product of claim 1, wherein said pre-colonized filter media is selected from the group of biological pin balls, biological ceramic rings, mini pads, Zeolite chips, carbon pellets and a combination of Zeolite chips and carbon pellets.

5. The product of claim 1, wherein said nitrifying Microorganisms are selected from the group consisting of Nitrosonomas, Nitrobacter, and Nitrospira.

6. A product for treating a body of water having organic waste matter contained therein, said product including a pre-colonized filter media contained in a prepackage, said pre-colonized filter media having been pre-colonized with herotroph microorganisms to enhance the biological oxidation of organic matter.

7. A method of treating a body of water having impurities therein including using a container having a filter media therein, said method including the steps of pre-colonizing said filter media with a nitrifying microorganisms, sealing said container and placing said container in a body of water having a water flow therein.

8. The method of claim 7, wherein said pre-colonized filter media is selected from the group consisting of biological pin balls, biological ceramic rings, mini pads, Zeolite chips, carbon pellets and a combination of Zeolite chips and carbon pellets.

9. The method of claim 7, wherein said nitrifying microorganisms are selected from the group consisting of nitrosomonas, nitrobacter, and nitrospira.

10. A method of treating a body of water having impurities therein including a container having a filter media therein, said method including the steps of pre-colonizing said filter media, said method including the steps of pre-colonizing said filter media with herotroph microorganisms.
